(19) United States
(12) Patent Application Publication
(10) Pub. No.: US 2016/0359314 A1
(43) Pub. Date: Dec. 8, 2016

(54) ADAPTIVE POWER DUMPER

(71) Applicant: Seagate Technology LLC, Cupertino, CA (US)

(72) Inventors: Suchet Rinsurongkawong, Samutprakarn (TH); Grant Nicholas Hester, Longmont, CO (US); John W. Rigsby, Longmont, CO (US)

(21) Appl. No.: 14/727,901

(22) Filed: Jun. 2, 2015

(51) Int. Cl. H02H 3/20

(52) U.S. Cl. CPC H02H 3/20

(57) ABSTRACT

Technologies are described herein for a power dumper module capable of adapting to power requirements of its implementation. An exemplary adaptive power dumper module includes a power dump circuit configured to dump excess regenerative energy from a load when a voltage at an output to the load exceeds a trip voltage level, and an adaptive circuit configured to select the trip voltage level from a plurality of trip voltage levels based on a bus voltage of a power supply supplying power to the load.

### BRIEF SUMMARY

The present disclosure relates to technologies for a power dumper module capable of automatically adapting to the power requirements of its implementation. According to some embodiments, an adaptive power dumper module comprises a power dump circuit configured to dump excess regenerative energy from a load when a voltage at an output to the load exceeds a trip voltage level, and an adaptive circuit configured to automatically select the trip voltage level from a plurality of trip voltage levels based on a bus voltage of a power supply supplying power to the load.

According to further embodiments, a method of automatically adapting a power dump circuit to a particular maximum bus voltage level of a power supply and load for which it is implemented comprises detecting the bus voltage supplied by the power supply to the load and selecting a trip voltage level for the power dump circuit from a plurality of trip voltage levels based on the bus voltage.

According to further embodiments, a system comprises a load, a power supply supplying a bus voltage to the load, and an adaptive power dumper module. The adaptive power dumper module is configured to dump excess regenerative energy from the load when a voltage at an output of the load exceeds a trip voltage level, the trip voltage level being automatically selected from a plurality of trip voltage levels based on the bus voltage.

These and other features and aspects of the various embodiments will become apparent upon reading the following Detailed Description and reviewing the accompanying drawings.

### BRIEF DESCRIPTION OF THE DRAWINGS

In the following Detailed Description, references are made to the accompanying drawings that form a part hereof, and that show, by way of illustration, specific embodiments or examples. The drawings herein are not drawn to scale. Like numerals represent like elements throughout the several figures.

FIG. 1 is a block diagram showing a system that utilizes an adaptive power dumper module, according to embodiments described herein.

FIG. 2 is a block diagram showing an illustrative adaptation circuit for the adaptive power dumper module, according to embodiments described herein.

FIGS. 3A-3C are circuit diagrams showing one implementation of the adaptive power dumper module, according to embodiments described herein.

FIG. 4 is a flow diagram showing one routine for automatically adapting a power dump circuit to a particular maximum bus voltage level of a power supply and load for which it is implemented, according to embodiments described herein.

### DETAILED DESCRIPTION

The following detailed description is directed to technologies for a power dumper module capable of automatically adapting to the power handling requirements of the environment in which it is implemented. A typical power dump circuit, also referred to as a regenerative power dump, protects a power supply from energy that may be regenerated by high inertial loads, such as a servomotor used in industrial equipment. During normal use, such a motor consumes power from the power supply. During deceleration of the motor, however, the motor becomes a generator and produces energy that is fed back to the power supply, called “regeneration.” The energy produced by regeneration is proportional to the kinetic energy of the moving parts of the motor and its load. In some situations, the regenerated energy can be excessive, potentially causing damage to the power supply and any intermediate servo drives or controllers.

In order to prevent damage to the power supply and other devices from excessive load regeneration, the power dump circuit senses the voltage at the power terminals of the load. If the voltage rises above a threshold value, e.g., 110% of the power supply bus voltage, the power dump circuit closes an internal switch and diverts the extra energy through a large power resistor, referred to as a “dump resistor” or “regen resistor.” The excess energy is dissipated as heat in the regen resistor, and voltage at the load terminals is reduced. It will be appreciated that the power dump circuit may switch the regen resistor in and out of the circuit iteratively as the voltage at the load terminals rises and falls and the regenerative energy is dissipated.

A conventional power dump circuit is designed and configured for the power requirements of the load and power supply in which it will be implemented. Design/configuration parameters may include the size of the regen resistor, the power dissipation rate, and the threshold voltage value, also referred to herein as the trip voltage level or “V_{TRIP}.” However, in most industrial or manufacturing environments, multiple sizes and configurations of power supplies, motors, and other loads exist, each potentially having a different maximum bus voltage rating and therefore different trip voltages, requiring multiple power dump circuit designs/implementations for each.

Utilizing the embodiments provided herein, an adaptive power dumper module may be implemented that is usable in a variety of configurations of power supply bus voltages. The adaptive power dumper module senses the incoming bus voltage and automatically determines the appropriate trip voltage to be used for the power dump circuit. The adaptive power dumper module may allow a single power dumper/regen control circuit design to be used in an environment regardless of the power supply or servo controller being used, without requiring any implementation-specific configuration or setup. This may eliminate incorrect setup errors of power dump circuits that may result in costly damage associated with over-voltage in a servo system.

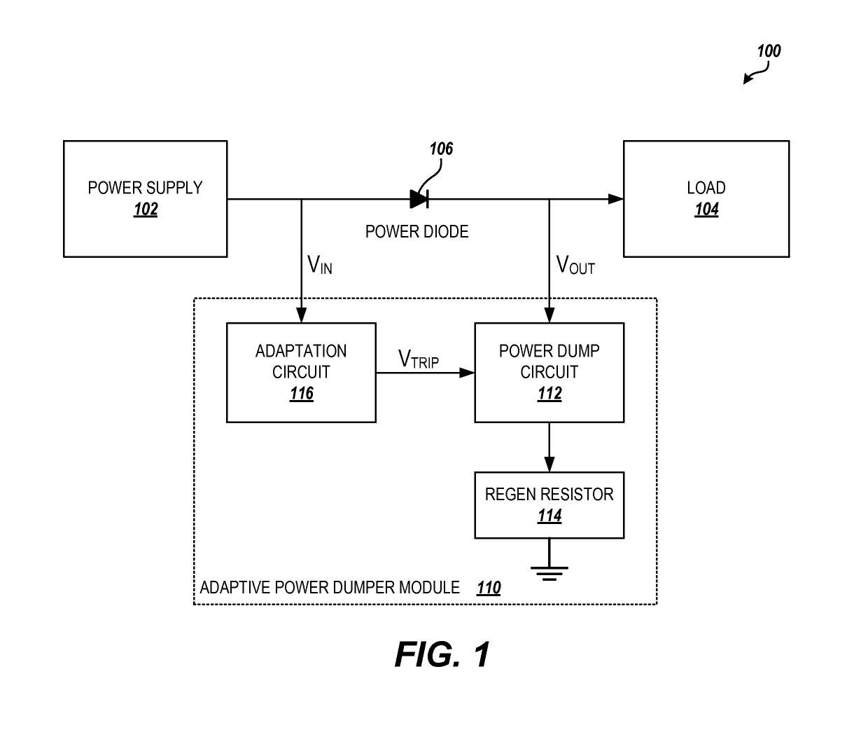

FIG. 1 provides an overview of an illustrative system 100 including an adaptive power dumper module 110, according to embodiments. The system 100 comprises a power supply 102 that supplies power to a load 104. The load 104 may comprise a servomotor utilized in industrial or manufacturing equipment, such as a motorized-screw linear actuator used in a computerized numerical control (“CNC”) drill or milling machine. According to some embodiments, the system 100 includes a power diode 106 between the power supply 102 and the load 104 to ensure current only flows from the power supply to the load. In further embodiments, the system 100 may include additional equipment on the load side of the power diode 106, such as a motor controller or servo drive. The power supply 102 may be configured to supply a specific bus voltage to the load 104 and/or the controller/drive.

The system 100 further includes the adaptive power dumper module 110. The adaptive power dumper module 110 comprises a power dump circuit 112 that can detect an increase in voltage at the load (labeled “V_{OUT}”) caused by regeneration. When the load voltage V_{OUT} exceeds a trip voltage level (labeled “V_{TRIP}”), the power dump circuit switches the load output to a regen resistor 114 that dissipates the excess energy, thus protecting the power supply 102 and other upstream components. According to embodiments, the adaptive power dumper module 110 further comprises an adaptation circuit 116. The adaptation circuit 116 detects the bus voltage (labeled “V_{IN}”) from the power supply 102 and automatically sets the appropriate trip voltage level V_{TRIP} for the power dump circuit 112. In this way, a single adaptive power dumper module design may be used in a variety of implementations of power supplies 102 and loads 104 requiring different bus voltages.

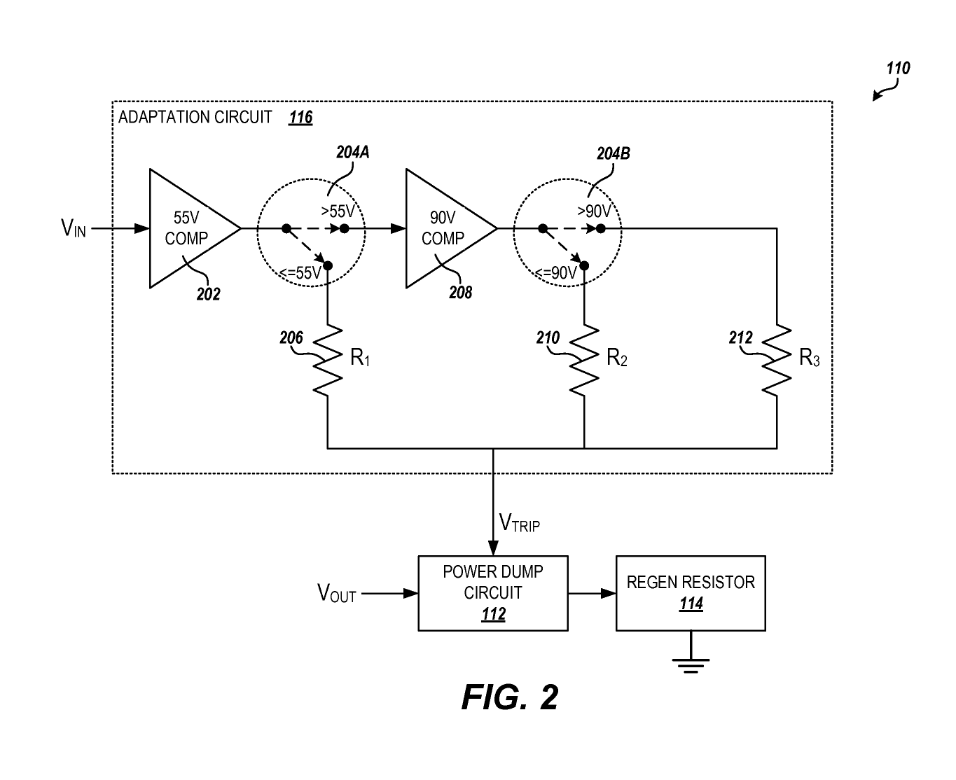

FIG. 2 shows one possible implementation of the adaptation circuit 116 of the adaptive power dumper module 110, according to some embodiments. This adaptation circuit 116 is setup to select three different V_{TRIP} values corresponding to the three different ranges of bus voltage V_{IN}. The adaptation circuit 116 of FIG. 2 may be useful in a manufacturing environment with three different integrated servo controllers implemented in various configurations in the assembly line, for example. The adaptation circuit 116 includes a first comparator circuit 202 configured to compare the bus voltage V_{IN} from the power supply 102 to a first threshold voltage, such as 55V. If the bus voltage V_{IN} is less than or equal to the first threshold voltage, then a solid-state relay circuit 204A switches a first resistor R₁ 206 into the power dump circuit 112 to set a first trip voltage level V_{TRIP1}.

If the bus voltage V_{IN} is greater than the first threshold voltage level, then the solid-state relay circuit 204A energizes a second comparator circuit 208 configured to compare the bus voltage V_{IN} to a second threshold voltage, such as 90V. If the bus voltage V_{IN} is less than or equal to the second threshold voltage, then another solid-state relay circuit 204B switches a second resistor R₂ 210 into the power dump circuit 112 to set a second trip voltage level V_{TRIP2} If the bus voltage V_{IN} is greater than the second threshold voltage level, then the solid-state relay circuit 204B switches a third resistor R₃ 212 into the power dump circuit 112 to set a third trip voltage level V_{TRIP3}.

Many other implementations of the adaptation circuit 116 may be imagined by one skilled in the art upon reading this disclosure. For example, an adaptation circuit 116 similar to that shown in FIG. 2 may be implemented that selects four, five, or more V_{TRIP} values corresponding to different ranges of bus voltage V_{IN}. Alternatively, an adaption circuit 116 may be configured to set the trip voltage level V_{TRIP} to a particular ratio of the detected bus voltage V_{IN}, such as 110%. In further examples, the adaptation circuit 116 may comprise a programmable digital controller or processor capable of setting various pre-programmed V_{TRIP} values based on detected bus voltage thresholds or bus voltage ranges. It is intended that all such variations of the adaptation circuit 116 be included in this application.

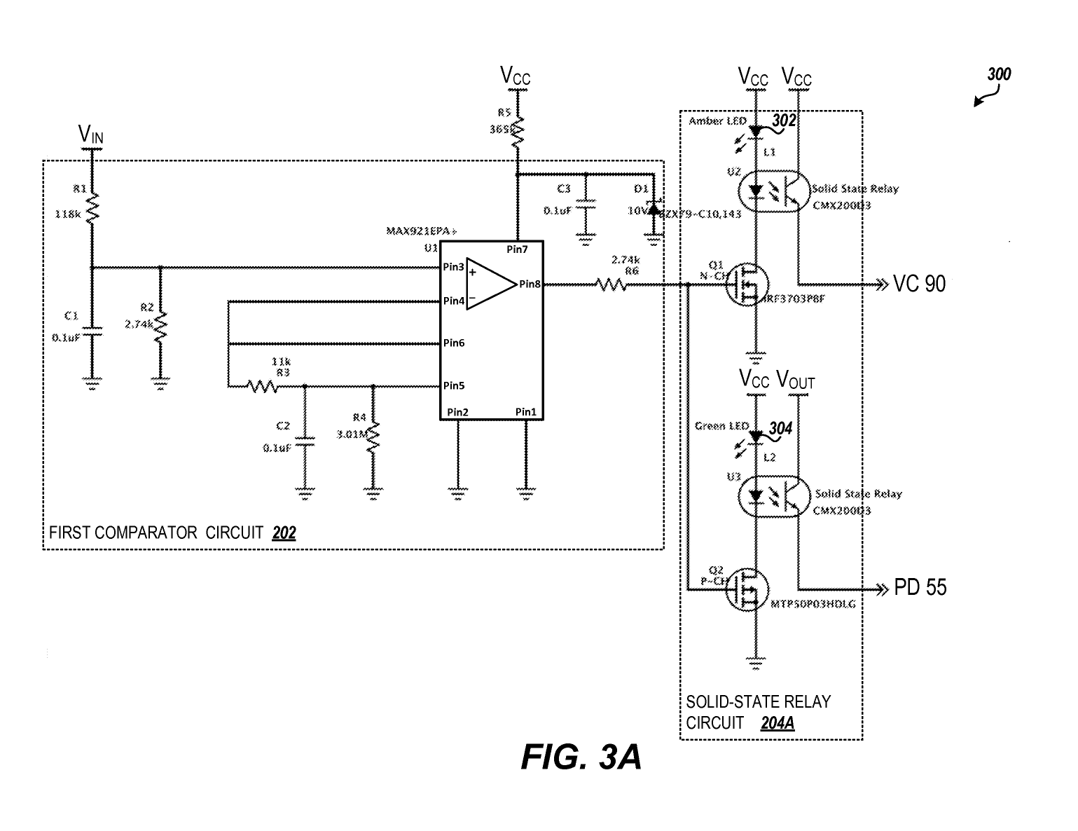

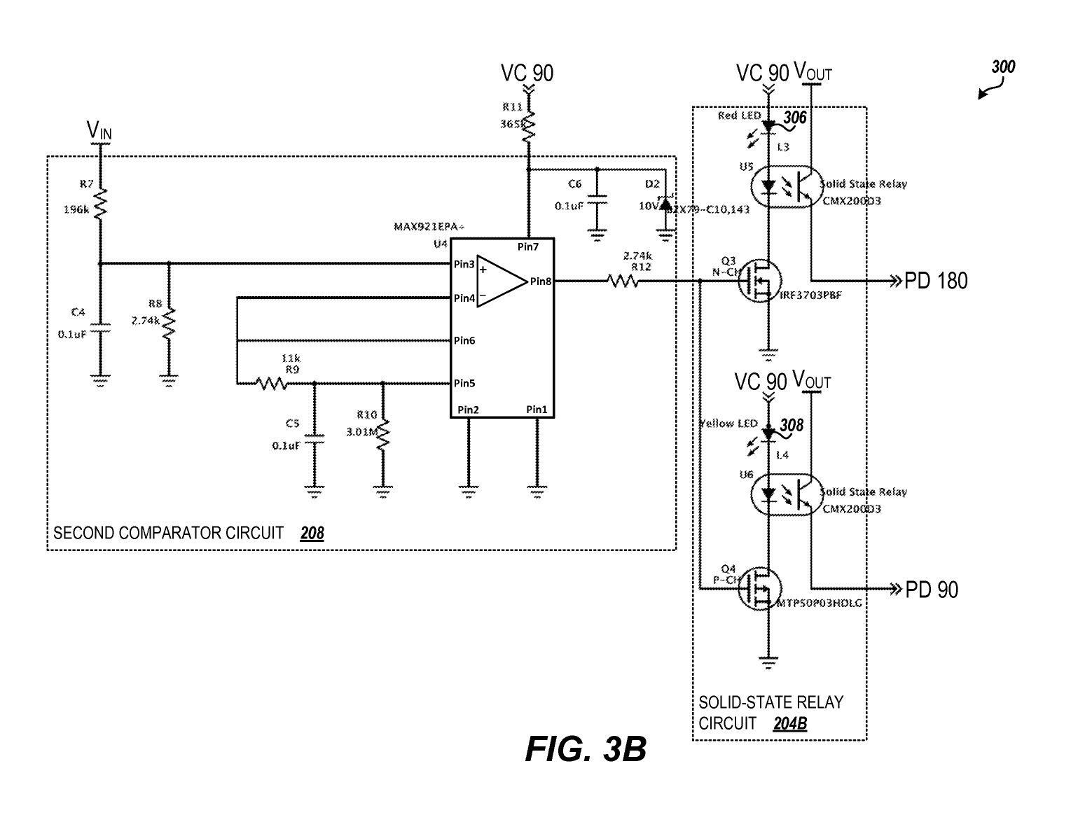

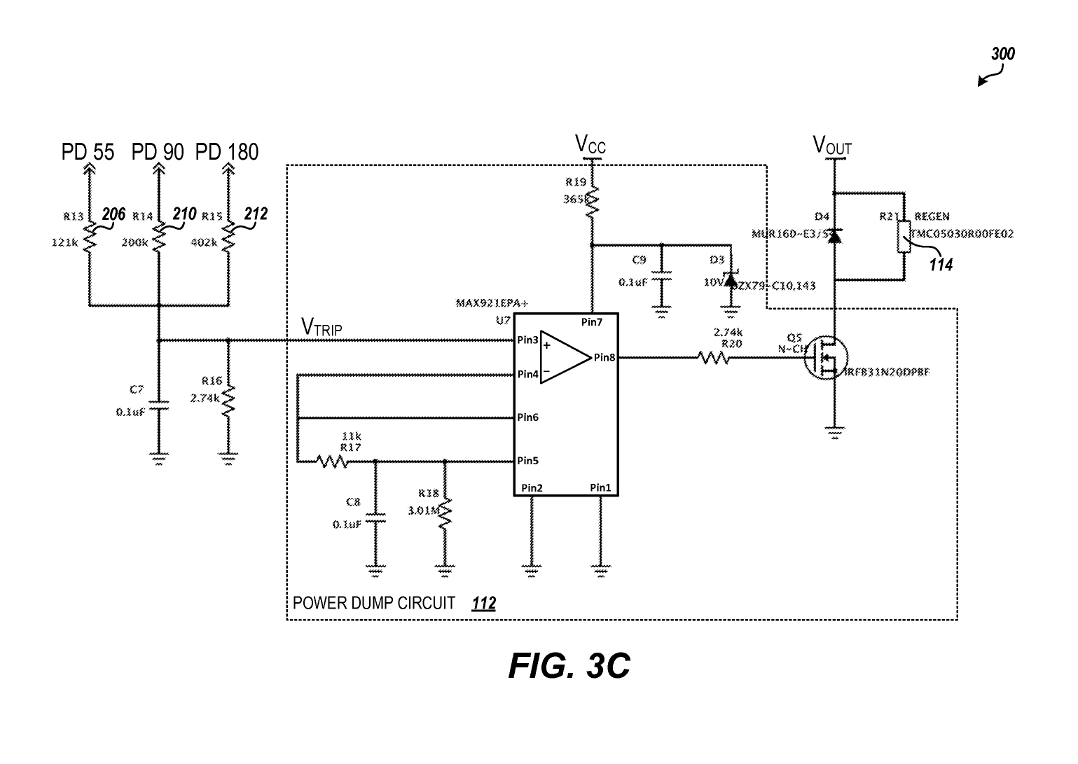

FIGS. 3A-3C provide an exemplary circuit 300 for an adaptive power dumper module 110, including an adaptation circuit 116 configured to provide three different V_{TRIP} values to the power dump circuit 112 corresponding to the three different ranges of bus voltage V_{IN}, as described above in regard to FIG. 2. The circuit 300 includes the first comparator circuit 202 driving the first solid-state relay circuit 204A and the second comparator circuit 208 driving the second solid-state relay circuit 204B to switch the three resistors 206, 210, and 212 into the circuit path from the load voltage V_{OUT} to the power dump circuit 112 to set the effective V_{TRIP} for the power dump circuit. The circuit 300 further includes the regen resistor 114.

According to some embodiments, the circuit 300 further includes status light-emitting diodes (“LEDs”) 302-308 to indicate the operational state of the adaptive power dumper module 110. For example, an amber status LED 302 may indicate the detected bus voltage is greater than the first threshold voltage. A green status LED 304 may indicate that the first trip voltage level V_{TRIP1} is selected for the power dump circuit 112, a yellow status LED 308 may indicate that the second trip voltage level V_{TRIP2} is selected for the power dump circuit, and a red status LED 306 may indicate that the third trip voltage level V_{TRIP3} is selected for the power dump circuit. Various other status LEDs may also be implemented indicating other operational states, such as when the power dump circuit 112 is active in channeling excess energy to the regen resistor 114, for example.

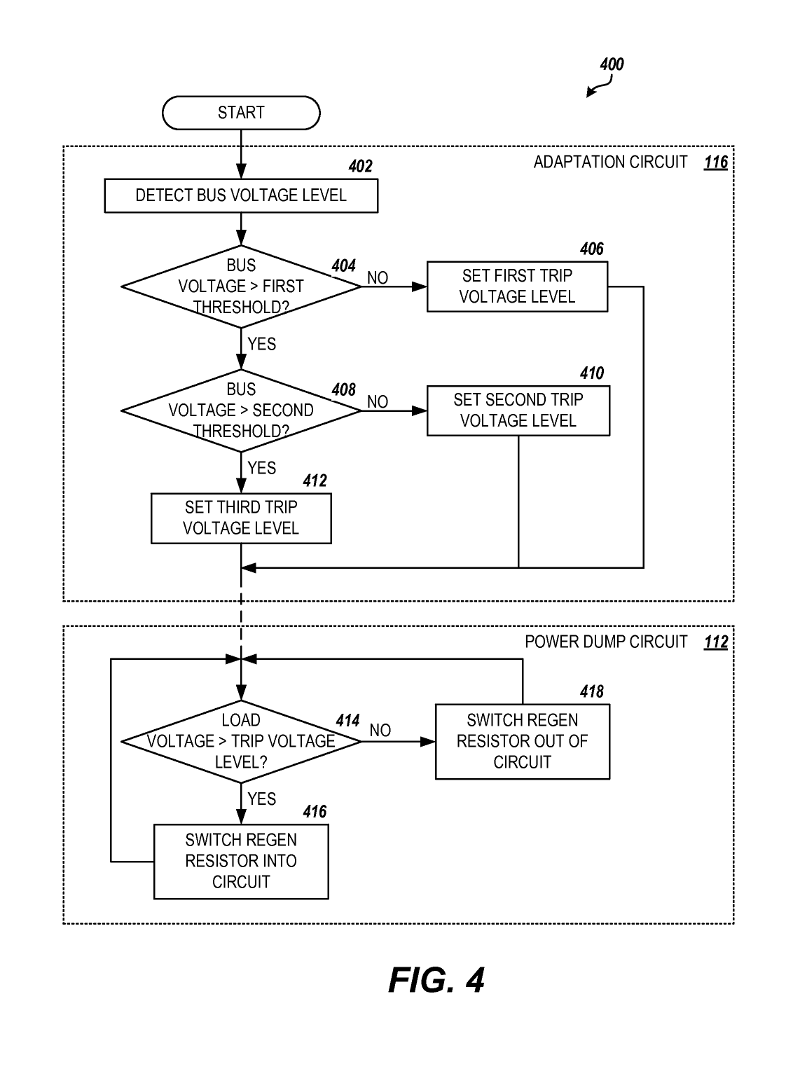

FIG. 4 illustrates one routine 400 for automatically adapting a power dump circuit 112 to a particular maximum bus voltage level of a power supply and load for which it is implemented, according to some embodiments. According to some embodiments, the routine 400 may be performed by the circuit 300 described above in regards to FIGS. 3A-3C. In further embodiments, the routine 400 may be performed by a programmable digital controller, a microcontroller, a field-programmable gate array (“FPGA”), a processor, or a combination of these and/or other digital and analog components and circuitry implemented in the adaptive power dumper module 110.

The routine 400 begins at step 402, where an adaptation circuit 116 of the adaptive power dumper module 110 detects the bus voltage V_{IN} supplied by the power supply 102 to the load 104. The bus voltage of the power supply 102 may be determined by using one or more comparator circuits, such as the first comparator circuit 202 and the second comparator circuit 208 described above in regard to FIGS. 2, 3A, and 3B. In other embodiments, the bus voltage level may be determined by an analog-to-digital converter (“ADC”) embedded in or connected to a microcontroller, for example. As shown at step 404, if the bus voltage V_{IN} is less than or equal to a first threshold voltage, then the routine 400 proceeds to step 406, where a first trip voltage level V_{TRIP1} is selected for the power dump circuit 112. For example, a solid-state relay circuit 204A may switch a first resistor R₁ 206 into the circuit path from the load voltage V_{OUT} to the power dump circuit 112 to set the effective V_{TRIP}. According to other embodiments, the adaptive circuit 116 may utilize a digital-to-analog converter (“DAC”) to set the desired V_{TRIP} value for a comparator in the power dump circuit 112.

If the bus voltage V_{IN} is greater than the first threshold voltage level, then the routine 400 proceeds from step 404 to step 408, where the bus voltage V_{IN} is compared to a second threshold voltage. If the bus voltage V_{IN} is less than or equal to the second threshold voltage, then the routine 400 proceeds to step 410, where a second trip voltage level V_{TRIP2} is selected for the power dump circuit 112. Similar to that described above in regard to step 406, this may be accomplished by a solid-state relay circuit 204B switching a second resistor R₂ 210 into the circuit path from the load voltage V_{OUT} to the power dump circuit 112. If the bus voltage V_{IN} is greater than the second threshold voltage level, then the routine 400 proceeds from step 408 to step 412, where a third trip voltage level V_{TRIP3} is selected for the power dump circuit 112. It will be appreciated that there may be any number of threshold voltages and corresponding trip voltage levels, depending on the requirements of the environment in which the adaptive power dumper module 110 is implemented.

As shown at step 414, the power dump circuit 112 compares the voltage level V_{OUT} at the terminals of the load 104 to the trip voltage level V_{TRIP} selected by the adaptation circuit 116. If the load voltage V_{OUT} exceeds the selected trip voltage level V_{TRIP}, then the routine 400 proceeds to step 416, where the power dump circuit 112 channels the excess voltage through the regen resistor 114 to be dissipated as heat. It will be appreciated that the power dump circuit 112 may switch the regen resistor 114 in and out of the circuit iteratively as the load voltage V_{OUT} rises and falls and the regenerative energy is dissipated, as further shown at steps 414, 416, and 418 in FIG. 4.

Based on the foregoing, it will be appreciated that technologies for a power dumper module capable of adapting to power requirements of its implementation are presented herein. It will be appreciated that while embodiments are show and described herein in regard to an analog device, any type combination of digital and analog components may be utilized to implement the described adaptive power dumper module 110. The above-described embodiments are merely possible examples of implementations, merely set forth for a clear understanding of the principles of the present disclosure.

The logical operations, functions, or steps described herein as part of a method, process or routine may be implemented (1) as a sequence of processor-implemented acts, software modules, or portions of code running on a controller or computing system and/or (2) as interconnected analog and/or digital circuits or components. The implementation is a matter of choice dependent on the performance and other requirements of the system. Alternate implementations are included in which operations, functions or steps may not be included or executed at all, may be executed out of order from that shown or discussed, including substantially concurrently or in reverse order, depending on the functionality involved, as would be understood by those reasonably skilled in the art of the present disclosure.

It will be further appreciated that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

Many variations and modifications may be made to the above-described embodiments without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

What is claimed is:

1. An adaptive power dumper module comprising:
a power dump circuit configured to dump excess regenerative energy from a load when a voltage at an output of the load exceeds a trip voltage level; and
an adaptation circuit configured to select the trip voltage level from a plurality of trip voltage levels based on a bus voltage of a power supply supplying power to the load.

2. The adaptive power dumper module of claim 1, wherein the adaptation circuit is configured to select from three different trip voltage levels corresponding to three different ranges of bus voltage.

3. The adaptive power dumper module of claim 2, wherein selecting from three different trip voltage levels comprises switching one of three different resistors into a circuit path between the output of the load and the power dump circuit based on the three different ranges of bus voltage.

4. The adaptive power dumper module of claim 1, wherein the adaptation circuit comprises a first comparator circuit driving a first solid-state relay circuit and a second comparator circuit driving a second solid-state relay circuit.

5. The adaptive power dumper module of claim 1, wherein the adaptation circuit is configured to:
detect the bus voltage supplied by the power supply;
compare the bus voltage to a first threshold voltage;
upon determining that the bus voltage is less than or equal to the first threshold voltage, select a first trip voltage level for the power dump circuit;
upon determining that the bus voltage is greater than the first threshold voltage, compare the bus voltage to a second threshold voltage;
upon determining that the bus voltage is less than or equal to the second threshold voltage, select a second trip voltage level for the power dump circuit; and
upon determining that the bus voltage is greater than the second threshold voltage, select a third trip voltage level for the power dump circuit.

6. The adaptive power dumper module of claim 5, wherein the first threshold voltage is 55 volts and the second threshold voltage is 90 volts.

7. The adaptive power dumper module of claim 1, wherein the load comprises a servomotor.

8. The adaptive power dumper module of claim 1, wherein the adaptation circuit further comprises a plurality of status light-emitting diodes configured to relate an operational state of the adaptive power dumper module.

9. A method of automatically adapting a power dump circuit to a particular maximum bus voltage level of a power supply, the method comprising steps of:
detecting a bus voltage supplied by the power supply to a load; and
selecting a trip voltage level for the power dump circuit from a plurality of trip voltage levels based on the bus voltage.

10. The method of claim 9, where the power dump circuit is configured to dump excess regenerative energy from the load when a voltage at an output of the load exceeds the selected trip voltage level.

11. The method of claim 10, wherein selecting the trip voltage level comprises switching one of three different resistors into a circuit path between the output of the load and the power dump circuit based on three different ranges of bus voltage.

12. The method of claim 9, wherein selecting the trip voltage level for the power dump circuit from the plurality of trip voltage levels comprises:
comparing the bus voltage to a first threshold voltage;
upon determining that the bus voltage is less than or equal to the first threshold voltage, selecting a first trip voltage level from the plurality of trip voltage levels for the power dump circuit;
upon determining that the bus voltage is greater than the first threshold voltage, comparing the bus voltage to a second threshold voltage;
upon determining that the bus voltage is less than or equal to the second threshold voltage, selecting a second trip voltage level from the plurality of trip voltage levels for the power dump circuit; and
upon determining that the bus voltage is greater than the second threshold voltage, selecting a third trip voltage level from the plurality of trip voltage levels for the power dump circuit.

13. The method of claim 12, wherein comparing the bus voltage to the first threshold voltage is performed by a first comparator circuit driving a first solid-state relay circuit, and comparing the bus voltage to the second threshold voltage is performed by a second comparator circuit driving a second solid-state relay circuit.

14. The method of claim 12, wherein the first threshold voltage is 55 volts and the second threshold voltage is 90 volts.

15. The method of claim 9, wherein the load comprises a servomotor.

16. A system comprising:
a load;
a power supply supplying a bus voltage to the load; and
an adaptive power dumper module configured to dump excess regenerative energy from the load when a voltage at an output of the load exceeds a trip voltage level, the trip voltage level automatically selected from a plurality of trip voltage levels based on the bus voltage.

17. The system of claim 16, wherein the adaptive power dumper module is configured to select from three different trip voltage levels corresponding to three different ranges of bus voltage.

18. The system of claim 17, wherein selecting from three different trip voltage levels comprises switching one of three different resistors into a circuit path between the output of the load and a power dump circuit based on the three different ranges of bus voltage.

19. The system of claim 16, wherein the adaptive power dumper module is configured to:
detect the bus voltage supplied by the power supply;
compare the bus voltage to a first threshold voltage;
upon determining that the bus voltage is less than or equal to the first threshold voltage, select a first trip voltage level from the plurality of trip voltage levels;
upon determining that the bus voltage is greater than the first threshold voltage, compare the bus voltage to a second threshold voltage;
upon determining that the bus voltage is less than or equal to the second threshold voltage, select a second trip voltage level from the plurality of trip voltage levels; and
upon determining that the bus voltage is greater than the second threshold voltage, select a third trip voltage level from the plurality of trip voltage levels.

20. The system of claim 16, wherein the adaptive power dumper module is further configured to relate an operational state of the adaptive power dumper module through a plurality of status light-emitting diodes.
